(19) United States
(12) Patent Application Publication
(10) Pub. No.: US 2014/0184535 A1
(43) Pub. Date: Jul. 3, 2014

(54) Method for Displaying Children Components in a Display that Operates at Different Screen Parameters and Orientations

(71) Applicant: Agilent Technologies, Inc., Loveland, CO (US)

(72) Inventor: Jonathan Helfman, Santa Clara, CA (US)

(21) Appl. No.: 14/056,826

(22) Filed: Oct. 17, 2013

Related U.S. Application Data
(60) Provisional application No. 61/746,508, filed on Dec. 27, 2012.

(51) Int. Cl. G09G 5/00; G09G 5/38

(52) U.S. Cl. CPC G09G 5/006; G09G 5/38
USPC 345/173; 345/156

(57) ABSTRACT

A method for controlling a display in a data processing system is disclosed. The method includes providing a layout file that includes a description of a parent panel and a plurality of children elements. A parent display specification in the layout file includes a specification for a plurality of different sub-view displays. Each sub-view display includes a different sub-set of the children elements and occupies a region on the display corresponding to the parent panel. A runtime system interprets the parent display specification and automatically generates the sub-view displays. A control element enables a user to signal the system to replace the current sub-view display with one of the other sub-view displays.

### CROSS-REFERENCE TO RELATED PATENT APPLICATIONS

This application is a conversion of, and claims priority therefrom, of U.S. Provisional Patent Application 61/746,508 filed on Dec. 27, 2012, said patent application being incorporated by reference herein.

### BACKGROUND

Graphical user interfaces (GUIs) often include a hierarchy of components. Refer to FIG. 1, which illustrates a GUI with two buttons. Display 20 includes a panel 21 that includes two buttons 22 and 23. The display can be viewed as a parent object, e.g., panel 21 that includes two children elements, e.g., buttons 22 and 23. The specification of the display is often provided in a language such as XML in which there is a 1-to-1 correspondence between “tags” in the XML specification and the interface components in the display. The hierarchy of components is reflected in the nesting of the tags in the XML specification. For example, the panel shown in FIG. 1 could be represented by the XML.

<Panel

layout_width=“match_parent”
layout_height-“match_parent”>
<button

layout_width=“wrap_content”
layout_height-“wrap_content”>
text=“button 1”/>

<button

layout_width=“wrap_content”
layout_height-“wrap_content”>
text=“button 2”/>

</Panel>

The runtime system that generates the display parses the XML file to provide the information used by various methods to generate the panel on the display of the data processing system that is running the application. For example, the runtime system will contain compiled code for implementing a button on the display and responding to events such as a user “pressing” the button.

This type of user interface specification is adapted to specifying interfaces that are expected to run on a data processing system having a display with a fixed size and aspect ratio. Each displayed object has a minimum size that is needed to view and operate on the object in the display. Hence, the display area must be sufficient to accommodate all of the displayed objects without requiring that any object be reduced in size to a level below this minimum size. In applications in which the available display area is known in advance, the programmer can design a layout that satisfies this condition. However, there are many cases in which this information is not known in advance. For example, user interfaces that run on mobile devices often need to run on a variety of different screen sizes, resolutions, orientations and aspect ratios.

To accommodate different target devices, some systems support multiple XML specification files and provide a mechanism for applications to load different XML files on different devices or to change XML files when a device changes orientation. While such approaches provide a better fit between the target devices and the application, maintaining multiple XML files complicates debugging and testing of the application and presents challenges in the maintenance of the system over time.

In addition, the designer has to design a number of different specific layouts to accommodate the different display configurations and sizes. This substantially increases the amount of work needed to design an interface that is to run on multiple devices.

### SUMMARY

The present invention includes a method for controlling a display in a data processing system. The method includes providing a layout file that includes a description of a parent panel and a plurality of children elements. A parent display specification in the layout file includes a specification for a plurality of different sub-view displays. Each sub-view display includes a different sub-set of the children elements and occupies a region on the display corresponding to the parent panel. A runtime system interprets the parent display specification and automatically generates the sub-view displays. A control element enables a user to signal the system to replace the current sub-view display with one of the other sub-view displays.

In one aspect of the invention, the control element includes a swipe panel, as defined below. In another aspect of the invention, the control element includes a navigation panel in each sub-view, the navigation having one button or icon for each sub-view display. One of the icons is highlighted, the highlighted icon specifying the current sub-view display in relation to others of the sub-view displays. A user signals the system to replace the current sub-view display with one of the other sub-view displays by selecting one of the icons.

In another aspect of the invention, the parent display specification specifies a first arrangement of the sub-view displays when the display is in landscape mode and a second arrangement of the sub-view displays when the display is in portrait mode. The runtime system switches between the first and second arrangements when the display switches between landscape and portrait modes.

### BRIEF DESCRIPTION OF THE DRAWINGS

FIG. 1 illustrates a GUI with two buttons.

FIG. 2 illustrates a number of different panel views that provide various sub-sets of the children in a form specified by the designer.

FIG. 3 illustrates the child sub-view displays shown in FIG. 2 on a display that utilizes a navigation map to move between displays.

FIG. 4 illustrates the organization of the sub-view displays in landscape mode for the children shown in FIGS. 2-3.

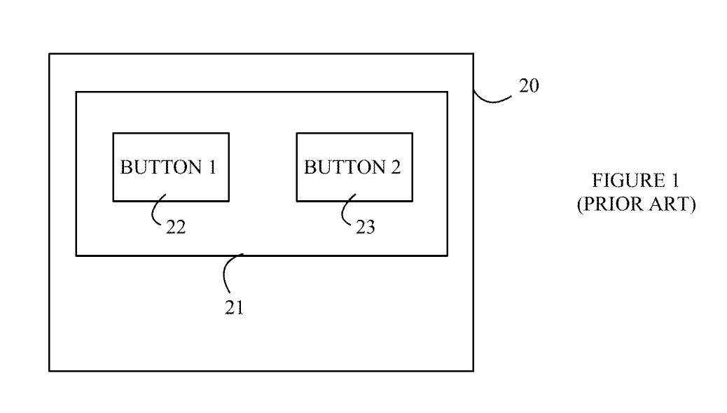

### DETAILED DESCRIPTION

The present invention utilizes a single layout file for all devices and orientations. Consider a display in which a parent display has multiple child displays. The parent display will be referred to as the panel display. The panel display occupies a predetermined region on the data processing display when the display is in a predetermined orientation, i.e., landscape or portrait.

The designer provides a description of the individual child displays in XML or a similar language. The designer also provides a specification for a number of different views that are to be provided. Each view includes a different sub-set of the child displays. The individual views will be referred to as sub-view displays in the following discussion. The runtime system interprets the XML file and generates the appropriate sub-view display according to this specification and provides a mechanism for moving from one sub-view display to another. Each sub-view display includes one or more of the children. Each sub-view display fits into the area reserved for the panel display on the data processing system display. The sub-view displays are implemented at run-time when the user swipes or selects a button by hiding, exposing, resizing, and repositioning the appropriate children.

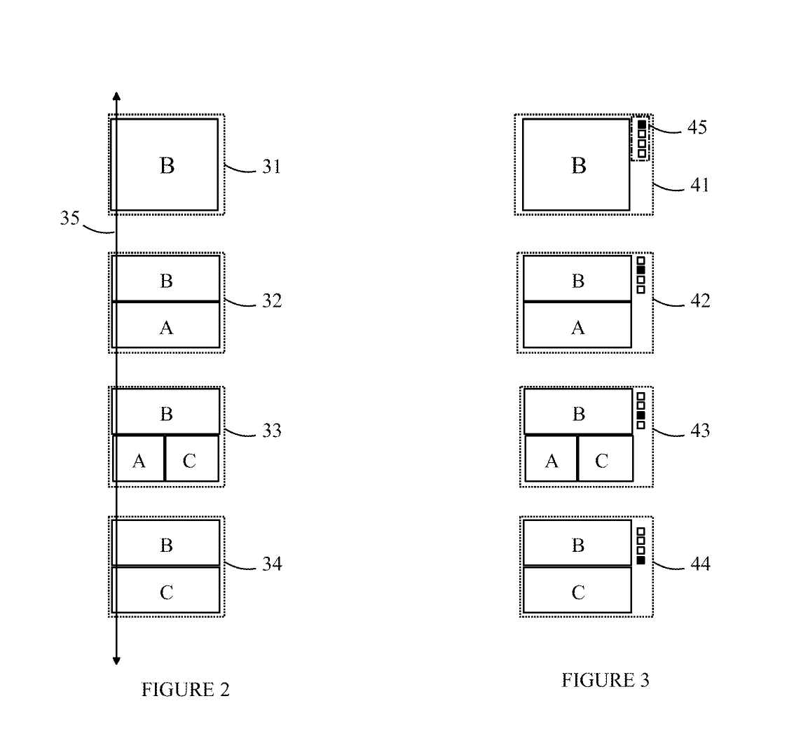

Consider a panel to be displayed on a mobile device in which the panel has three children, denoted by A, B, and C. It is assumed that all three children cannot be displayed at once in vertical portrait display within the region allocated for that panel. Refer now to FIG. 2, which illustrates a number of different panel views that provide various sub-sets of the children in a form specified by the designer. The dotted rectangle in each display represents the view seen by a user of the display in the panel area when that sub-view is presented. In the present invention, the designer specifies the desired sub-view displays in a statement in the XML description of the interface. An example of such a specification is as follows:
childviews=“B; B,A; B,AC; B,C”

In one aspect of the invention, the layout engine that provides the various display configurations assigns the names “A”, “B”, . . . to the children in the order in which the children are defined in the XML file. However, embodiments in which the language provides a name assignment statement that defines names that the user prefers to use in referring to the children can also be utilized. In those cases, those names would be used in the specification statement defining the sub-view displays.

In the exemplary layout statement shown above, each sub-view display ends with a “;”. Sub-view displays that contain a “,” specify that the child before the “,” is placed vertically over the child after the “,”. Two children that are not separated by a “,” are to be placed adjacent to one another horizontally. Hence, the first sub-view display 31 has the single child B. The second sub-view display 32 has the two children, B and A arranged vertically. The third sub-view display 33 has child B over children A and C arranged horizontally. The final sub-view display 34 has the children B and C arranged vertically.

The user of the display moves from one sub-view display to another sub-view display by swiping a finger on the display as shown at 35 in the example shown in FIG. 2. For the purposes of this discussion, a swipe panel will be defined to be a region of the screen, possibly overlapping other regions, that responds to user input in the form of gestures, particularly touch or selection events immediately followed by drag events in which the horizontal coordinate of the drag events varies more than some preset amount within a preset time period. Thus when the user performs a swipe gesture as described above when sub-view display 34 is being viewed, the display shifts to sub-view display 33 or sub-view display 31, depending on the direction of the swipe.

However, other arrangements for navigating between sub-view displays could be utilized. Refer now to FIG. 3, which illustrates the sub-view displays shown in FIG. 2 on a display that utilizes a navigation map to move between sub-view displays. Sub-view displays 41-44 correspond to sub-view displays 31-34, respectively. Each sub-view display includes a navigation panel 45, which represents the various sub-view displays with the sub-view display currently displayed highlighted in some manner. The navigation panel 45 includes buttons or icons that represent each of the sub-view displays. When the user who is viewing one of the sub-view displays wishes to move to a different sub-view display, the user selects the icon in the navigation panel in the current sub-view display that corresponds to the sub-view display to which the user wishes to move. The manner in which the user selects the icon in question depends on the particular device. On a device with a touch screen or screen that is responsive to a stylus, the user can touch or click on the icon in question.

Embodiments in which a navigation panel responds to swipe gestures as well as button or icon selections can also be utilized. In this case, a navigation panel that includes buttons or other icons is also a swipe panel. For example, navigation panel 45 shown in FIG. 3 could itself be a swipe panel that displays different sets of icons in response to the swipe motion. This feature allows the navigation panel to be larger than the area of the display needed to display all of the navigation icons at a size compatible with the user selecting an icon by touching the icon.

The above-described embodiments assume that the display mode is portrait. In the landscape mode, an analogous organization is automatically generated. The landscape mode can be specified by setting a property, i.e.
childviewsLandscape=“B; B,A; B,AC; B,C”

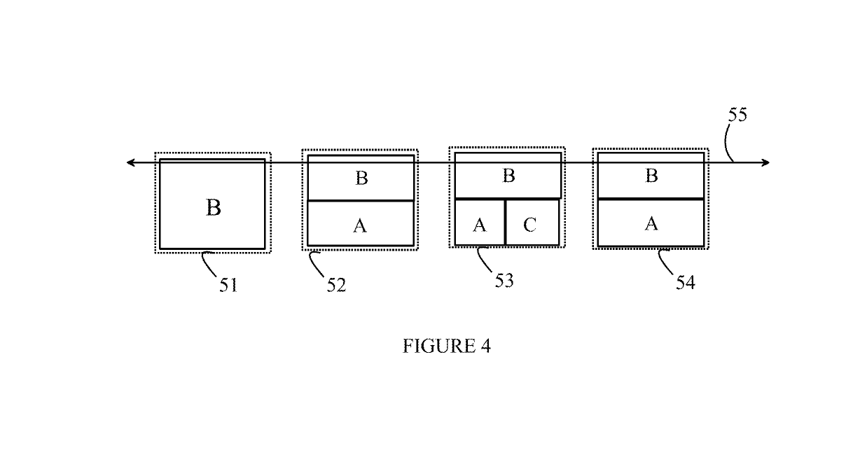

Refer now to FIG. 4, which illustrates the organization of the sub-view displays in landscape mode for the children shown in FIGS. 2-3. The sub-view displays corresponding to sub-view displays 31-34 shown in FIG. 2 are shown at 51-54, respectively. In this example, the user changes sub-view displays by using a swiping motion as indicated by the arrow at 55.

In the present invention, the runtime system that parses the layout description file automatically generates the sub-view displays from the grouping specification provided by the display designer. The designer provides the description of each of the children and information that defines the sizes of the children. The sub-view display generating engine does the rest. Hence, the designer is freed of the need for designing a display for each possible device. In addition, the designer only needs to maintain one display description file.

In one aspect of the invention, the runtime system adjusts the sizes of the various child components to fill the available space in the particular sub-view display being generated. Refer again to FIG. 2. The space allocated for child B in sub-view display 31 is greater than the space allocated to child B in the other sub-view displays. Similarly, the space allocated to child A in sub-view display 32 is greater than the space allocated to child A in sub-view display 33.

In one aspect of the invention, a mode is provided in which each child has its own sub-view display in which that child occupies all of the available space on the screen. This mode is particularly useful for devices with very small displays, i.e., less than 300 pixels in the smallest dimension. Embodiments in which the designer sets a fixed size for a particular child display component can also be utilized; however, such embodiments may not scale for all possible display sizes and orientations.

The above-described embodiments have a single panel on the data processing display. However, the present invention can be utilized in data processor displays having multiple panels in which more than one panel has children that are displayed in that panel's portion of the data processor display utilizing the method of the present invention. In such embodiments, each panel has its own navigation mechanism for changing the sub-view display in that panel while leaving the sub-view displays in the other panels unchanged.

The present invention also includes a computer readable medium that stores instructions that cause a data processing system to execute the method of the present invention. A computer readable medium is defined to be any medium that constitutes patentable subject matter under 35 U.S.C. 101. Examples of such media include non-transitory media such as computer memory devices that store information in a format that is readable by a computer or data processing system.

The above-described embodiments of the present invention have been provided to illustrate various aspects of the invention. However, it is to be understood that different aspects of the present invention that are shown in different specific embodiments can be combined to provide other embodiments of the present invention. In addition, various modifications to the present invention will become apparent from the foregoing description and accompanying drawings. Accordingly, the present invention is to be limited solely by the scope of the following claims.

What is claimed is:

1. A method for controlling a display in a data processing system, said method comprising:
providing a layout file comprising a description of a parent panel and a plurality of children elements;
providing a parent display specification in said layout file, said parent display specification comprising a specification for a plurality of different sub-view displays, each sub-view display comprising a different sub-set of said children elements and occupying a region on said display corresponding to said parent panel;
providing a runtime system that interprets said parent display specification and automatically generates said sub-view displays; and
providing a control element that enables a user to signal the system to replace the current sub-view display with one of the other said sub-view displays.

2. The method of claim 1 wherein said control element comprises a swipe panel.

3. The method of claim 1 wherein said control element comprises a navigation panel in each sub-view, said navigation panel having one icon or button for each sub-view display.

4. The method of claim 3 wherein one of said icons is highlighted, said highlighted icon specifying the current sub-view display in relation to others of said sub-view displays.

5. The method of claim 4 wherein a user signals said runtime system to replace the current sub-view display with one of the other sub-view displays by selecting one of said icons.

6. The method of claim 1 wherein said parent display specification specifies a first arrangement of said sub-view displays when said display is in landscape mode and a second arrangement of said sub-view displays when said display is in portrait mode.

7. The method of claim 6 wherein said runtime system switches between said first and second arrangements when said display switches between landscape and portrait modes.

8. The method of claim 1 wherein said layout file comprises an XML file and wherein said parent display specification comprises a definition within said XML file.

9. A computer readable medium comprising instructions that cause a data processing system to execute a method for operating a display that is part of said data processing system, said method comprising:
providing a layout file comprising a description of a parent panel and a plurality of children elements;
providing a parent display specification in said layout file, said parent display specification comprising a specification for a plurality of different sub-view displays, each sub-view display comprising a different sub-set of said children elements and occupying a region on said display corresponding to said parent panel;
providing a runtime system that interprets said parent display specification and automatically generates said sub-view displays; and
providing a control element that enables a user to signal the system to replace the current sub-view display with one of the other said sub-view displays.

10. The computer readable medium of claim 9 wherein said control element comprises a swipe panel.

11. The computer readable medium of claim 9 wherein said control element comprises a navigation panel in each sub-view, said navigation panel having one icon or button for each sub-view display.

12. The computer readable medium of claim 11 wherein one of said icons is highlighted, said highlighted icon specifying the current sub-view display in relation to others of said sub-view displays.

13. The computer readable medium of claim 12 wherein a user signals said runtime system to replace the current sub-view display with one of the other sub-view displays by selecting one of said icons.

14. The computer readable medium of claim 9 wherein said parent display specification specifies a first arrangement of said sub-view displays when said display is in landscape mode and a second arrangement of said sub-view displays when said display is in portrait mode.

15. The computer readable medium of claim 14 wherein said runtime system switches between said first and second arrangements when said display switches between landscape and portrait modes.

16. The computer readable medium of claim 9 wherein said layout file comprises an XML file and wherein said parent display specification comprises a definition within said XML file.
